(19) United States
(12) Patent Application Publication
(10) Pub. No.: US 2011/0060640 A1
(43) Pub. Date: Mar. 10, 2011

(54) SYSTEM, METHOD AND APPARATUS FOR PROVIDING MESSAGES TO A TRANSACTION INSTRUMENT

(75) Inventors: Kirk J. Thompson, Coral Springs, FL (US); Hitesh K. Seth, East Windsor, NJ (US)

(73) Assignee: AMERICAN EXPRESS TRAVEL RELATED SERVICES CO., INC., New York City, NY (US)

(21) Appl. No.: 12/554,142

(22) Filed: Sep. 4, 2009

(51) Int. Cl. G06Q 30/00; G06F 15/16; H04B 7/216; G09G 3/36; G06K 19/06

(52) U.S. Cl. 705/14.36; 705/14.58; 705/14.65; 709/206; 370/342; 345/87; 235/494

(57) ABSTRACT

Methods, systems, and apparatuses enable a card issuer to provide messages to a customer's transaction instrument. In accordance with one embodiment of the present invention, there is provided a method for providing messages to customer. The method includes receiving a request for messages corresponding to a transaction instrument of a user at a server. The method further includes obtaining information associated with the transaction instrument using the request. The method further includes selecting at least one message, based at least in part, on the information associated with the transaction instrument. The at least one message is selected from a messages database. The method further includes providing the at least one message to the transaction instrument.

### BACKGROUND OF THE INVENTION

1. Field of the Invention

The present invention generally relates to the field of providing offers, servicing information, and other information to customers, and more particularly to providing offers, servicing information, and other information using transaction instruments equipped with an electronic display.

2. Related Art

Financial transaction cards, such as credit cards, debit cards, charge cards, pre-paid cards, etc., are becoming increasingly popular as a mode of payment for customers all over the world. Financial transaction cards offer customers, hereinafter, interchangeably referred to as card members, the convenience of making payments to merchants without a need to carry physical currency with them at all times.

It may be advantageous for merchants to target this large population of potential customers, to effectively market their products and/or services. For this purpose, the merchants may have an agreement and/or partnership with card issuers to provide marketing material, promotional content, advertisements, information on loyalty programs and the like, collectively referred to as offers, to the card members. Even the card issuers may wish to send different offers or servicing information to their card members for various purposes, for example, launching a new card. To make the offers more attractive to the card members, the card issuers and/or the merchants may give other benefits, such as cash back, discounts, higher loyalty program points and the like, to the card members for purchasing the advertised product or service with their financial transaction cards. Moreover, many customers may also be interested in receiving the latest offers to inform their decision of making their purchases.

Currently, card issuers provide such offers to their card members by including the offers in card statements of the card members or sending mailers via a postal service. According to another technique, the offers are sent to the card members via emails. Alternatively, the card issuers may send the offers through Short Message Service (SMS) messages, or Multimedia Messaging Service (MMS) messages to the card member's mobile devices.

However, current techniques for providing offers to customers are expensive and/or not very effective. The card statements are typically delivered to customers once every month. Therefore, offers sent with the card statement may not always be up-to-date. Also, cost constraints usually put a limit on the number of offers that may be provided in this manner. Informing customers of the latest offers using SMS or MMS sent to customers' mobile devices or sending the offers via e-mails may reduce this delay to a large extent. However, such messages may be lost in a large number of other SMS messages, MMS messages and/or emails received by the customer and it may be difficult for the customer to retrieve an appropriate offer when the customer visits a particular merchant store.

Further, it is typically the customer's responsibility to call a card issuer or access a website of a card issuer to receive any servicing information, such as the current credit limit of a card, the balance remaining on a card, etc. Currently, there are some modes other than calling or accessing a website to receive such information, such as emails, SMS messages, etc. However, as discussed above, these messages may be lost in a large number of other messages.

Given the foregoing problems, a system, a method and an apparatus for providing messages, such as offers and servicing information, to customers in an effective manner are needed.

### BRIEF DESCRIPTION OF THE INVENTION

The present invention can meet the above-identified needs by providing methods, systems, and apparatuses for providing messages to a customer. The customer carries a transaction instrument. According to an embodiment of the present invention, the transaction instrument is enabled with a wireless communication system and an electronic display for presenting information to the customer. One or more messages relevant to the customer are selected using information associated with the transaction instrument and the selected messages are sent to the transaction instrument. The transaction instrument presents the messages to the customer on the electronic display on the financial transaction instrument. Various embodiments of the present invention provide an advantage of providing messages to the customer in a convenient manner without the customer having to carry another mobile device for receiving the messages. Another advantage is that the customer can be informed about the latest offers related to a merchant when the customer is at the merchant's store, thus enabling the customer to avail himself or herself of offer benefits at the merchant's store. Another advantage is providing quick and direct information to a customer regarding servicing information, such as an account balance, on the transaction instrument. According to a further advantage, the customer can store the messages on the transaction instrument and can view or retrieve the messages at a later time in an easy manner.

In accordance with one embodiment of the present invention, there is provided a method for providing messages to a customer. The method includes receiving, at a server, a request for messages from a transaction instrument of the customer. The method further includes obtaining information associated with the transaction instrument using the request for messages. The method further includes selecting at least one message, from a message database, based, at least in part, on the information associated with the transaction instrument. The at least one message is selected from a messages database. The method further includes providing data corresponding to the at least one message to the transaction instrument.

In accordance with another embodiment of the present invention, there is provided a system for providing messages to a customer. The system includes a messages database for maintaining a plurality of messages. The system further includes a server including a receiving module for receiving a request for messages from a transaction instrument of the customer. The server further includes an information retrieval module for obtaining information associated with the transaction instrument of the customer using the request. The server further includes a selection module for selecting at least one message from the messages database based, at least in part, on the information associated with the transaction instrument. The server includes a sending module for sending data corresponding to the at least one message to the transaction instrument.

In accordance with yet another embodiment of the present invention, there is provided an apparatus for providing messages to a customer. The apparatus includes a discovery module for discovering a transaction instrument of the customer. The apparatus further includes a communication module for forwarding a request for messages corresponding to the transaction instrument to a server. The communication module further forwards data corresponding to at least one message received from the server to the transaction instrument.

In accordance with still another embodiment of the present invention, there is provided a transaction instrument of a customer. The transaction instrument includes a transmission module for transmitting a request for messages corresponding to the transaction instrument to a server. The transaction instrument further includes a reception module for receiving at least one message from the server. The transaction instrument further includes a display for presenting the at least one message to the customer.

Further features and advantages of the present invention as well as the structure and operation of various embodiments of the present invention are described in detail below with reference to the accompanying drawings.

### BRIEF DESCRIPTION OF THE DRAWINGS

The features and advantages of the present invention will become more apparent from the detailed description set forth below when taken in conjunction with the drawings in which like reference numbers indicate identical or functionally similar elements.

FIG. 1 is an exemplary environment in which a message delivery system may be used;

FIG. 2 is another exemplary environment in which the message delivery system may be used;

FIG. 3 is a block diagram illustrating an exemplary implementation of the message delivery system;

FIG. 4 is a block diagram illustrating an exemplary implementation of a communication node;

FIGS. 5A and 5B are schematic illustrations of an exemplary implementation of a financial transaction instrument;

FIGS. 6A and 6B illustrate exemplary messages displayed on the transaction instrument;

FIG. 7 is a flowchart illustrating one example process for providing messages to a customer; and

FIG. 8 is a block diagram of an exemplary computer system for implementing the present invention.

### DETAILED DESCRIPTION

### I. Overview

The present invention is directed to systems, methods and apparatuses for providing messages to customers using transaction instruments. The transaction instruments have wireless communication circuitry and an electronic display. The transaction instrument receives and displays messages to the customer. One or more messages relevant to the customer are selected using information associated with the transaction instrument and the selected messages are sent to the transaction instrument.

In an embodiment, the present invention is for use with financial transaction instruments including traditional plastic financial transaction cards (e.g., a credit card, a charge card, a debit card, a pre-paid, gift, or stored value cards, or the like), titanium-containing, or other metal-containing, financial transaction cards, foldable or otherwise unconventionally-sized financial transaction cards, radio-frequency enabled financial transaction cards, or other types of financial transaction cards. A financial transaction instrument may also have electronic functionality provided by a network of electronic circuitry that is printed or otherwise incorporated onto or within the financial transaction instrument (and typically referred to as a “smart card”). The financial transaction instrument may also be, for example, a fob having a transponder and an RFID reader.

A “card issuer” is any entity that maintains a financial transaction account for customers to conduct financial transactions using a financial transaction instrument. For example, any company that provides members with financial transaction instruments and thereby maintains corresponding financial transaction accounts may be a card issuer. Another example of a card issuer may be a health insurance company for providing messages to an insured customer via a transaction instrument.

A “merchant” is any entity that is a provider, broker and/or any other entity in the distribution chain of products or services. For example, a merchant may be a retail store, a travel agency, a restaurant, a hotel, a service provider, an on-line merchant, a doctor, and the like.

A “point-of-sale device” or “POS device” is any device or system, used at a merchant's establishment, capable of wireless communication. One example of a POS device is an RFID enabled information kiosk.

### II. System

The present invention is now described in terms of an exemplary system, hereinafter referred to as a “message delivery system,” in which the present invention, in one embodiment, would be implemented. This is for convenience only and is not intended to limit the application of the present invention. It will be apparent to one skilled in the relevant art(s) how to implement the present invention in alternative embodiments.

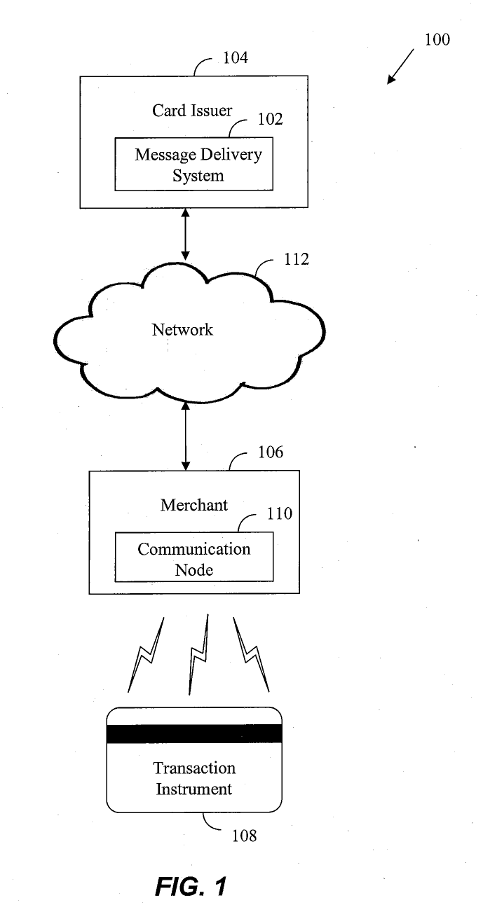

Various embodiments of the present invention may be deployed in different scenarios. In one exemplary scenario, a card issuer may have an agreement and/or partnership with a merchant and when the card issuer's customer is at the merchant's establishment, the card issuer may provide messages, for example offers, to the customer related to the merchant on the customer's financial transaction instrument issued by the card issuer. The customer may then avail himself or herself of the offers using only the transaction instrument. Hereinafter, such a scenario is referred to as a “closed loop environment.” FIG. 1 illustrates an exemplary closed loop environment 100 in which an message delivery system 102 may be used, according to one embodiment of the present invention. In this case, a card issuer 104 may have an agreement and/or partnership with a merchant 106. Card issuer 104 uses message delivery system 102 to deliver offers to a transaction instrument 108 of card issuer's 104 customer.

In various embodiments, a communication node 110 may be used at merchant's 106 establishment, for example, a store, a franchise, a restaurant, etc., for detecting transaction instrument 108. In one embodiment, communication node 110 may detect transaction instrument 108 automatically when the customer carrying transaction instrument 108 moves within the vicinity of communication node 110, for example, when the customer enters merchant's 106 establishment. Alternatively, the customer may be required to manually hold transaction instrument 108 near, for example, within 10 centimeters, to communication node 110.

In various embodiments, communication node 110 may be located at an entrance of merchant's 106 establishment to facilitate automatic discovery of transaction instrument 108 when the customer enters merchant's 106 establishment or when the customer passes outside merchant's 106 establishment. In other embodiments, communication node 110 may be integrated with a Point-of-Sale (POS) device at merchant's 106 establishment. In additional embodiments, communication node 110 may be implemented as a separate kiosk terminal at merchant's 106 establishment. In further embodiments, multiple communication nodes 110 may be distributed across merchant's 106 establishment, for example, at different sections in a department store. Depending upon the relationship and/or agreement between card issuer 104 and merchant 106, communication node 110 may be deployed by card issuer 104 or by merchant 106. In some embodiments, a third party may deploy communication node 110.

Upon discovery of transaction instrument 108, communication node 110 receives a request from transaction instrument 108 for messages corresponding to transaction instrument 108. Communication node 110 relays the request to message delivery system 102. Communication node 110 may also send merchant-specific information along with the request to message delivery system 102. The merchant specific information may include name of the merchant, location of the merchant's establishment, category of products or services offered by the merchant, and the like. Communication node 110 may also include additional information, such as an identifier of communication node 110, date and time of the request, etc., in the request.

Using the request, message delivery system 102 obtains information associated with transaction instrument 108. The information associated with transaction instrument 108 may include, but is not limited to, one or more of a transaction instrument issuer name, a transaction instrument type, a transaction instrument number, a transaction instrument account number, a transaction instrument account type, a loyalty program number, loyalty program points, a loyalty program identifier and the like.

Message delivery system 102 then selects one or more messages based, at least, upon the information associated with transaction instrument 108. Message delivery system 102 may also use additional information, for example, the merchant-specific information, customer-specific information and the like, to select the one or more messages. Various embodiments for selecting the one or more messages are explained later. Thereafter, message delivery system 102 sends the selected messages to communication node 110 which then forwards the selected messages to transaction instrument 108. In some embodiments, message delivery system 102 may also send an offer code corresponding to each of the one or more messages. Communication node 110 may relay the offer codes to transaction instrument 108.

Transaction instrument 108 includes a display (not shown in FIG. 1) and presents the received messages to the customer on the display. The customer may browse through the one or more messages. The customer may then select a desired message and perform an associated activity, for example, purchase a product or service, redeem loyalty program points, etc., using transaction instrument 108 to avail the customer of benefits corresponding to the desired message. In one embodiment, the customer may be required to present the offer code corresponding to the desired message.

Message delivery system 102 and communication node 110 communicate over a network 112. Examples of network 112 include a wide area network (WAN), a local area network (LAN), an Ethernet, Internet, an Intranet, a cellular network, a satellite network, or any other suitable network for transmitting data. Network 112 may be implemented as a wired network, a wireless network or a combination thereof.

Although card issuer 104 and merchant 106 are shown as different entities in FIG. 1, in some embodiments, card issuer 104 and merchant 106 may be the same entity. For example, merchant 106 may issue transaction instruments 108 to its customers and may wish to provide messages to the customer on their transaction instruments 108. The transaction instrument 108, in this case, may be a pre-paid card, a gift card, a loyalty card or the like. In such a situation, merchant 106 may deploy message delivery system 102 and communication node 110 at its establishment. In one embodiment, merchant 106 may own multiple individual establishments, for example, stores, restaurants, hotels, or movie theaters, etc., spread over a wide geographical area. In this case, merchant 106 may deploy message delivery system 102 at its head-office or a central franchise and communication node 110 at individual establishments to deliver offers to its customers.

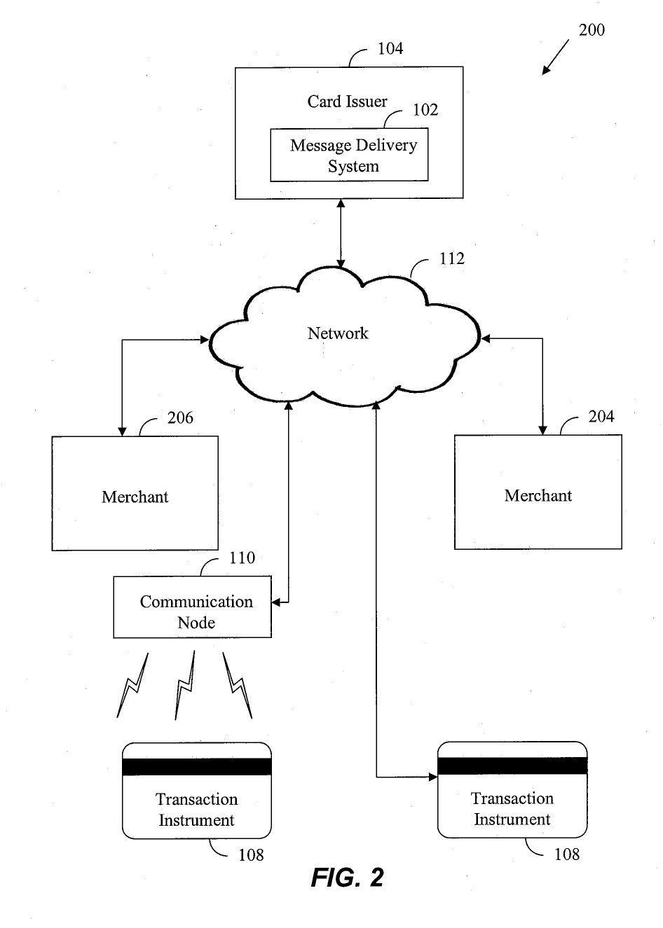

Various embodiments of the present invention may also be implemented in an “open loop environment.” In one open loop scenario, the card issuer 104 may not have a partnership with any specific merchant for providing messages to the card issuer's 104 customers. In such a case, the messages may relate to the use of the transaction instrument 108 issued by the card issuer 104 and the customer may avail himself or herself of benefits corresponding to the messages at any merchant of the customer's choice by using that transaction instrument 108. FIG. 2 illustrates an exemplary open loop environment 200 in which message delivery system 102 may be used, according to another embodiment of the present invention. In this case, card issuer 104 deploys message delivery system 102 and communication node 110. In one exemplary implementation, card issuer 104 may provide communication node 110 at a place where multiple merchant establishments may be located, for example, at an airport, although other such places such as a shopping complex, a train station, etc., may be considered without deviating from the spirit and scope of the present invention.

When the customer enters the premises of the place where multiple merchant establishments may be located, communication node 110 may discover transaction instrument 108 of the customer, as described earlier. In one embodiment, communication node 110 may be implemented as a kiosk terminal. In another embodiment, communication node 110 may be implemented as a wireless access point. Thereafter, communication node 110 receives a request for offers from transaction instrument 108 and forwards the request to message delivery system 102 over network 112.

In another exemplary implementation, message delivery system 102 communicates directly with transaction instrument 108 through network 112. In this case, message delivery system 102 discovers transaction instrument 108 automatically. According to one embodiment, message delivery system 102 may use, via network 112, any of various wide area network (WAN) technologies known in the art, for example, Global System for Mobile communications (GSM), Code Division Multiple Access (CDMA), Universal Mobile Telecommunication system (UMTS), General Packet Radio Service (GPRS), Third Generation packet networks (3G), High-Speed Downlink Packet Access (HSDPA) or Worldwide Interoperability for Microwave Access (IEEE 802.16 WIMAX) to communicate with transaction instrument 108. Further, message delivery system 102 may use any of various short range network devices known in the art, such as Bluetooth®, ZigBee®, near field communication (NFC), etc., to communicate with transaction instrument 108.

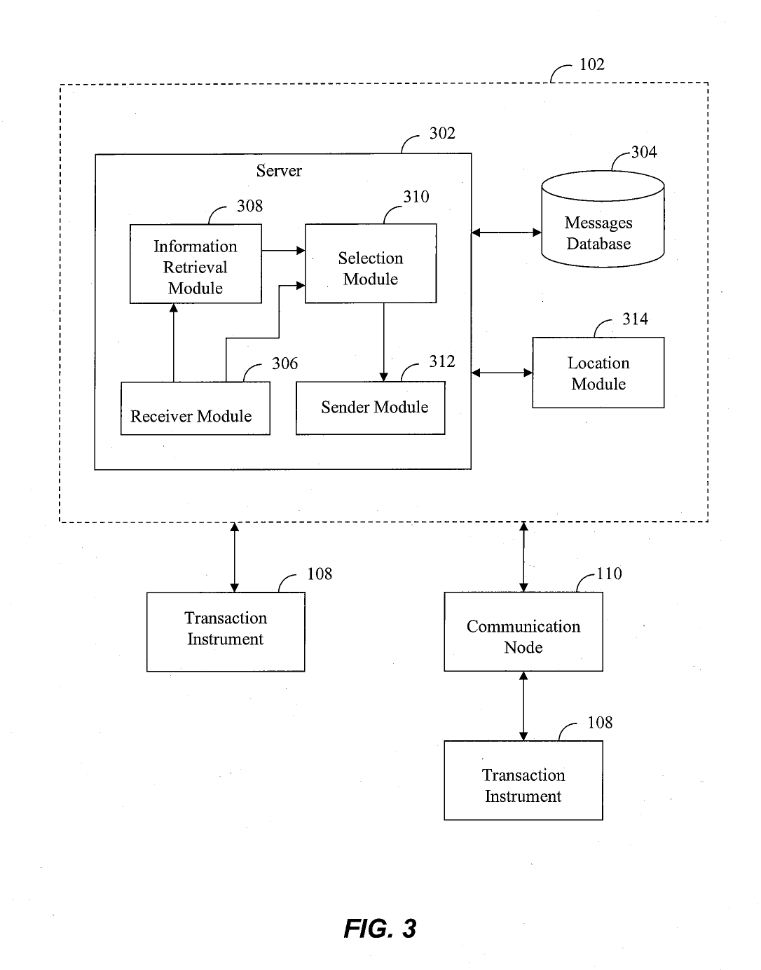

Once transaction instrument 108 is discovered, message delivery system 102 receives the request for offers from transaction instrument 108, either directly from transaction instrument 108 or via communication node 110, which will be described more fully below with respect to FIG. 3. Message delivery system 102 then obtains the information associated with transaction instrument 108 using the request. In one embodiment, message delivery system 102 may also determine a location of transaction instrument 108 using, for example, Global Positioning System (GPS) technique, though various other location estimation techniques known in art may also be used. Message delivery system 102 then selects one or more offers using the information associated with transaction instrument 108. In one embodiment, message delivery system 102 may also use the location of transaction instrument 108 for selecting the one or more offers. In an exemplary scenario described herein, the selected offers may correspond to use of transaction instrument 108 at any merchant, for example, merchant 202 and/or merchant 204 shown in FIG. 2, of the customer's choice. An example of such an offer may be “Shop with your Credit Card while you travel and earn double loyalty program points!” A person skilled in the art will recognize other similar offers that may be provided to the customer.

Depending upon the implementation, message delivery system 102 may send the one or more messages directly to transaction instrument 108, or to communication node 110, which in turn forwards the one or more messages to transaction instrument 108. Transaction instrument 108 displays the one or more messages to the customer. The customer may select a desired message, make purchases according to the desired message using transaction instrument 108 and get benefits associated with the desired message.

Further, various embodiments of the present invention may also be deployed in scenarios where a merchant may have an agreement and/or partnership with the card issuer to provide messages, for example, a notification of a special sale, to the card issuer's customers on behalf of the merchant. However, unlike earlier scenarios, the customer may avail himself or herself of the benefits provided by the messages using any mode of payment, for example, financial transaction instruments issued by other card issuers, gift vouchers, cash and the like, and may not be required to use only the financial transaction instrument issued by the card issuer that delivers the message. The merchant may pay a fee to the card issuer for this purpose.

Though message delivery system 102 and communication node 110 are shown as separate components in FIGS. 1 and 2, message delivery system 102 may include communication node 110 in various embodiments.

FIG. 3 illustrates an exemplary implementation of message delivery system 102, according to one embodiment of the present invention. Message delivery system 102 includes a server 302 and a messages database 304. Server 302 includes a receiver module 306, an information retrieval module 308, a selection module 310, and a sender module 312. Receiver module 306 and sender module 312 are configured to communicate with transaction instrument 108 and/or communication node 110 over network 112 (not shown in FIG. 3).

In some embodiments, message delivery system 102 further includes a location module 314. Location module 314 determines the geographical location of transaction instrument 108 using various techniques known in the art, such as Global Positioning System (GPS), cellular tower triangulation techniques, a network of Wi-Fi Access Points and Access Point location databases, and so on.

Messages database 304 maintains a plurality of offers. The offers may be stored as text, images, moving images or any combination thereof. Further, messages database 304 may associate each message with corresponding transaction instrument information, merchant specific information and/or geographic location. Messages database 304 may also store an offer code, a validity period and the like, for each message.

Receiver module 306 receives the request for messages, corresponding to transaction instrument 108, either directly or indirectly from the transaction instrument 108. In an exemplary embodiment, when communication node 110 acts as an intermediary for communications between message delivery system 102 and transaction instrument 108, receiver module 306 receives the request via communication node 110. In another exemplary embodiment, receiver module 306 may receive the request directly from transaction instrument 108. In additional embodiments, receiver module 306 may also receive additional information, such as the merchant specific information and/or the geographic location of transaction instrument 108 along with the request.

Upon receipt of the request, information retrieval module 308 obtains information associated with transaction instrument 108, hereinafter interchangeably referred to as card information, using the request. The card information includes one or more of a transaction instrument issuer name, a transaction instrument type, a transaction instrument number, a transaction instrument account number, a transaction instrument account type, a membership number, loyalty program points, a loyalty program identifier and the like.

In one exemplary embodiment, the request may include a token corresponding to transaction instrument 108, and information retrieval module 308 extracts the token from the request. Information retrieval module 308 may look-up the card information in a card information database (not shown in FIG. 3) using the token. The token may represent one or more card information fields. For example, the token may denote the transaction instrument type, i.e., all transaction instruments of the same type (for example, “Gold Cards”) have the same token. Similarly, all transaction instruments issued under the same loyalty program may have the same token. A person skilled in the art will recognize other suitable examples of the token representing the card information. In various embodiments, the token may uniquely identify a particular transaction instrument. In this case, information retrieval module 308 may also retrieve information about the customer owning the transaction instrument. Examples of the customer information include, but are not limited to, name, address, demographic information, likes, dislikes, preferences, etc., of the customer. In one embodiment, the token may be encrypted for security purposes using various known techniques, for example, Data Encryption Standard (DES), Advanced Encryption Standard (AES), Public Key Infrastructure (PKI) and the like. In this case, information retrieval module 308 may need to decrypt the token before using the token.

In another exemplary embodiment, the card information may be embedded in the request. Information retrieval module 308 may then extract the card information directly from the request. The card information may be encrypted, in one embodiment.

Information retrieval module 308 passes the card information, and any other information retrieved using the request, to selection module 310. Selection module 310 selects relevant messages from messages database 304 using the card information. Selection module 310 may query messages database 304 using any of the techniques known in the art. In one exemplary implementation, the selected messages may depend upon only one information field, for example, the transaction instrument type, of the card information. In this case, same messages are selected for all customers having a “Gold Card.” Similarly, same messages are selected for all customers having a “Platinum Card,” where the offers selected for the customers with “Gold Card” and the customers with “Platinum Card” may be the same or different. In another exemplary implementation, selection module 310 may use more than one information field of card information. For example, an offer “Earn double points on your Platinum Card for hotel bookings. Offer valid through 15 Aug. 2009” may be selected only for customers having a “Platinum Card” (i.e., transaction instrument type) and that are members of a “Trusted Member Scheme” (i.e., loyalty program).

In additional embodiments, selection module 310 may also select the messages using the merchant specific information. For example, if the merchant specific information indicates that the customer is at Levi's® New York store, selection module 310 may select an offer “Get 5% cash back on purchasing your favorite Jeans with your Card” that corresponds to the Levi's® New York store. On the other hand, for Levi's® Washington store, selection module 310 may select a different offer, for example, giving double loyalty program points to Platinum card holders (transaction instrument type) on purchase of more than $2000 in a month at Levi's® Washington store.

In some embodiments, selection module 310 may also use the geographical location of transaction instrument 108 while selecting the messages. An example of selection of a message using the geographical location may be when the customer having transaction instrument 108 is in the vicinity of a fine dining restaurant and the customer has sufficient loyalty program points that the customer can redeem to earn free buffet coupons for a couple at that restaurant.

In additional embodiments, selection module 310 may select the messages using the customer information. For example, if the customer is at a sports retail store and the customer is a football fan, then selection module 310 may select a message about football apparel and accessories that is valid for the customer's transaction instrument.

A person skilled in the art will appreciate that various examples described above of selecting the messages are for illustrative purposes only. Further, one skilled in the art will recognize numerous other variations of selecting messages without deviating from the spirit and scope of the present invention.

Although many of the examples discussed above are related to offers, a person skilled in the art will recognize that the messages can also be different from offers. For example, a card issuer 104 may wish to send servicing information to the transaction instrument 108. The servicing information could include information such as account balances, payment due dates, loyalty program reward balances, alerts to the customer regarding charges over certain amounts, and the like. For example, selection module 310 may select a message such as “A purchase over $500 has been charged to your account.” This specific example can be beneficial if an account number of a financial transaction instrument has been stolen. The customer would be alerted immediately on the transaction instrument 108 of a purchase over a certain amount.

Selection module 310 then passes the selected messages to sender module 312. Depending upon the deployment scenario, sender module 312 sends the selected messages to either communication node 110 or transaction instrument 108.

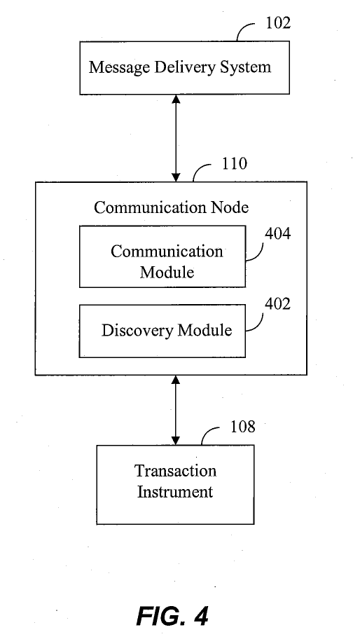

FIG. 4 illustrates an exemplary implementation of communication node 110, according to one embodiment of the present invention. In various embodiments, communication node 110 acts as an intermediary for communication between message delivery system 102 and transaction instrument 108. Depending upon the relationship and/or agreement between card issuer 104 and merchant 106, communication node 110 may be deployed by card issuer 104, by merchant 106, or by a third party. Communication node 110 includes a discovery module 402 and a communication module 404. For example, communication node 110 may be a transaction instrument 108 user's cell phone. The cell phone may act as an intermediary between message delivery system 102 and transaction instrument 108.

Discovery module 402 aids in discovery of transaction instrument 108. In one exemplary implementation, discovery module 402 may use Radio Frequency Identification (RFID) technology, for example, ISO/IEC 14443 Standard, to discover transaction instrument 108. In this case, discovery module 402 may periodically transmit interrogatory signal pulses. The discovery process is complete when discovery module receives a valid response to the interrogation pulses from transaction instrument 108. Discovery module 402 then establishes a communication channel with transaction instrument 108. A person skilled in the art will appreciate that other wireless communication technologies, such as, without limitation, Wireless Fidelity (IEEE 802.11 Wi-Fi), Bluetooth®, Near Field Communication (NFC) and the like, may be also used for discovering the financial transaction instrument, without deviating from the spirit and scope of the present invention. Depending upon the range and capability of the technology used, discovery module 402 may automatically discover transaction instrument 108 or the customer may be required to hold transaction instrument 108 at discovery module 402 within the range dictated by the technology.

Upon establishment of the communication channel, communication module 404 may receive a request for messages from transaction instrument 108 over the communication channel. Communication module 404 forwards the request to message delivery system 102. In one embodiment, communication module 404 may convert the request in a format compatible with network 112 before forwarding the request to message delivery system 102. In addition, communication module 404 may also transmit the merchant specific information along with the request, according to one embodiment. In another embodiment, communication module 404 may add an identifier of communication node 110 and message delivery system 102 may retrieve the merchant specific information from a merchant database. Communication module 404 may modify the request to include the merchant specific information or may send the merchant specific information separately.

Communication module 404 also receives one or more messages corresponding to one or more messages from message delivery system 102 over network 112. In one embodiment, all messages may be received in a single communication. Alternatively, one communication may correspond to one message. In yet another embodiment, one communication may include more than one message. Communication module 404 forwards the one or more messages to transaction instrument 108. Communication module 404 may convert the messages to a format compatible with the technology used for communication with transaction instrument 108.

In some embodiments, communication module 404 may not receive explicit request for messages. Instead, discovery module 402 may forward the response to interrogation pulses to communication module 404 and communication module 404 may treat this response as the request for messages. In other embodiments, upon receiving the interrogation pulses, transaction instrument 108 may transmit a request for messages. The request may be received by discovery module 402 and the discovery module 402 may treat the request as a valid response to complete the discovery process.

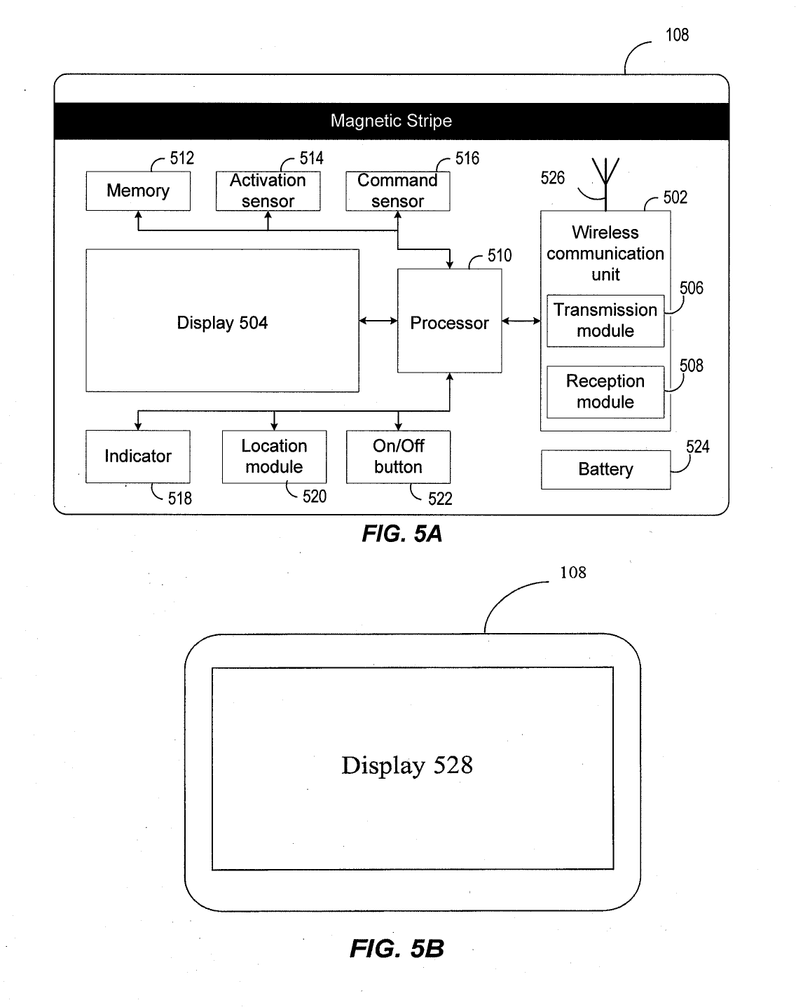

FIGS. 5A and 5B are block diagrams of an exemplary implementation of transaction instrument 108, according to one embodiment of the present invention. In one exemplary implementation, transaction instrument 108 is a magnetic stripe financial transaction card. Transaction instrument 108 includes a wireless communication unit 502 and a display 504. In an exemplary implementation, transaction instrument 108 may further include a processor 510, and a memory 512. According to one embodiment, financial transaction may further include a battery 524 for supplying power to various components of transaction instrument 108.

Wireless communication unit 502 communicates with various components of message delivery system 102 and/or communication node 110 and may be implemented using any of various wireless technologies known in the art, such as Wi-Fi, Bluetooth®, RFID, NFC, GSM, CDMA, UMTS, GPRS, 3G, HSDPA, WiMAX and the like. Wireless communication unit 502 sends signals via an antenna 526. Wireless communication unit 502 further includes a transmission module 506 and a reception module 508. During the discovery process, reception module 508 receives periodic interrogation pulses from either the message delivery system 102 or communication node 110. Transmission module 506 transmits response signals to the message delivery system 102 or communication node 110 during the discovery process. In some embodiments, transmission module 506 may also transmit initiation pulses to the message delivery system 102 or communication node 110 to initiate the discovery process. That is, the discovery process may be initiated by the message delivery system 102, the communication node 110 or transmission mode 506 of the transaction instrument 108. Further, transmission module 506 transmits the request for messages either directly to message delivery system 102 or to communication node 110. Reception module 508 receives the messages for presentation to the customer on display 504 from either communication node 110 or message delivery system 102 depending upon the implementation.

Display 504 presents the received messages to the customer possessing transaction instrument 108. Display 504 may be implemented using any of the suitable display technologies, such as, Liquid Crystal Display (LCD), Light Emitting Diode (LED), Organic Light Emitting Diode (OLED), electronic paper such as the E-ink® imaging film manufactured by the E Ink Corporation, Interferometric MOdulator Display (IMOD) such as Mirasol™ technology manufactured by Qualcomm® and the like. Display 504 may be backlit. In one exemplary implementation, display 504 may also display other information, such as financial transaction card number, financial transaction card type, validity period of the financial transaction card, loyalty program, name of the customer, an image of the customer and the like. In one embodiment, such information may be pre-stored in memory 512 when transaction instrument 108 is issued or may be downloaded to memory 512 from message delivery system 102 when transaction instrument 108 is discovered for the first time. With this capability, card issuer 104 may eliminate the need of replacing transaction instrument 108 in event of an upgrade of card type, a renewal of validity period and the like. In additional embodiments, the customer may personalize display 504 by configuring display 504 to display an image of the customer's favorite football team, a personal message, a slogan or the like. Preferences for the display may be set by a customer visiting the card issuer's website or calling a call center to access the card information and set specific options and features for presentation on the card and capabilities.

In one embodiment, the display may be separated into two separate display units with one display unit displaying the messages and the other display unit displaying the card information and/or the personalized content. For example, as shown in FIG. 5B, a display unit 528 displaying the card information and/or the personalized content may be located on a front side of transaction instrument 108. The display unit 504 presenting messages may be located on a back side of transaction instrument 108, as shown in FIG. 5A, or vice versa.

Memory 512 stores the messages received by reception module 508. In one embodiment, memory 512 may store the messages for a pre-defined period, for example, for one day, according to an exemplary implementation. In another exemplary implementation, memory 512 may store a message as long as the message is valid, that is, if an message is valid for a month, memory 512 stores that message for a month. In an exemplary embodiment, the customer may instruct transaction instrument 108 to store messages of interest to the customer for longer than the pre-defined period. In one embodiment, processor 510 may automatically delete messages older than the pre-defined period or messages past their validity period to accommodate newer messages. Processor 510 controls storage and retrieval of messages to and from memory 512. Processor 510 may access the messages using a First-in-First-out (FIFO) scheme, Last-in-First-out (LIFO) scheme or in a random manner.

In an embodiment, memory 512 may also store the card information and/or the token representing the card information. Additionally, memory 512 may also store the customer's preferences such as genres of music and movies, cuisines, favorite stores, hobbies, likes and dislikes, security preferences and the like. In one exemplary embodiment, the customer specifies his preferences to card issuer 104, such as by a website, call center or the like, and card issuer 104 in turn updates the contents of memory 512 with the preferences.

In one exemplary embodiment, memory 512 is a secure memory that stores data using various encryption techniques known in the art. The data, such as the token, the card information and/or the customer preferences, may be decrypted only by card issuer 104. Card issuer 104 may update the contents of memory 512, for example, update card type (for example, from a Gold card to a Platinum card), change card member loyalty program scheme, renewal of card validity period, etc. In one embodiment, contents of memory 512 may be erased by card issuer 104 using a remote command in various situations, such as theft or loss of transaction instrument 108 and the like.

In various embodiments, processor 510 controls overall functioning of transaction instrument 108. Any known low power consumption microprocessor designed for applications, such as a smart card, may be employed as processor 510, according to one embodiment. For example, processor 510 may be an embedded processor manufactured by any of Motorola, Hitachi, Digital, etc. Processor 510 executes software code for controlling and coordinating the functioning of various components of transaction instrument 108. In one exemplary implementation, the software code may be implemented using an embedded programming environment, such as JAVA, although a person skilled in the art will appreciate that any other suitable programming language may be used without deviating from the spirit and scope of the invention. In one embodiment, the software code may be stored on internal memory of processor 510. Alternatively, the software code may be stored in memory 512 and accessed by processor 510. Various functions of processor 510 include, but are not limited to, decoding interrogation messages received by reception module 508, preparing response messages to the interrogation messages, preparing the request for messages, encrypting the token and/or the card information to be sent in the request for messages, decoding the messages received by reception module 508, storing and retrieving messages from memory 512, formatting the messages for presentation on display 504, driving display 504 and the like. For example, a message may be an offer including a two-dimensional barcode of the offer in addition to the text corresponding to the message. Processor 510 may then modify the message such that the displayed message includes the text as well as the two-dimensional barcode of the offer in a format that can be scanned by a barcode reader at the merchant's point-of-sale terminal.

Transaction instrument 108 may further include one or more of at least one activation sensor 514, at least one command sensor 516, and at least one indicator 518, according to an embodiment. To reduce power consumption, display 504 may be activated only when required and may be deactivated when not required. Activation sensor 514 detects a trigger for activating display 504. In one exemplary implementation, activation sensor 514 is a light sensor. The light sensor detects ambient light intensity and sends appropriate signals to processor 510. For example, the light sensor may be used to detect whether transaction instrument 108 is in the customer's wallet (no ambient light) or the customer has taken transaction instrument 108 out of the wallet, and accordingly disable or enable display 504, respectively. This reduces power consumption and extends battery life.

Further, the customer may need to issue different commands to transaction instrument 108 for different purposes, such as, without limitation, scrolling through a message, browsing through various messages, retrieving messages stored in memory 512, or switching on and switching off wireless communication unit 502, etc. Command sensor 516 accepts user inputs corresponding to the commands and sends the user inputs to processor 510, which in turn issues appropriate commands. In one exemplary implementation, command sensor 516 is an acceleration sensor and the customer may need to shake transaction instrument 108 in specific motions to issue various commands. For example, shaking the card from side to side may instruct transaction instrument 108 to scroll through the messages, while shaking the card vertically may issue commands for storing the messages as messages of interest for the customer. Further, flicking the card may issue commands for switching on and switching off wireless communication unit 502.

In some embodiments, activation sensor 514 may be used in conjunction with command sensor 516 to prevent issuance of commands when not intended by the customer. For example, command sensor 516 may accept inputs only when activation sensor 514 detects a valid trigger. For example, when transaction instrument 108 is outside the customer's wallet, it is more likely that the customer may be providing valid inputs by shaking or flicking the card. On the other hand, the acceleration sensor may experience similar shaking motion, for example, when the customer is walking, even though transaction instrument 108 is inside the customer's wallet. A person skilled in the art will appreciate that other sensors such as, but not limited to, pressure sensors, ambient sound sensors, and strain sensors, may be used as the command sensor and/or the activation sensor.

Indicator 518 provides an alert to the customer when a new message is received. In one exemplary implementation, indicator 518 is implemented using a vibration motor for providing a vibrating alert to the customer. In one exemplary embodiment, indicator 518 may be activated considering the status of activation sensor 514. For example, the vibration alert may be deployed only when the light sensor detects that transaction instrument 108 is in the customer's wallet. A person skilled in the art will appreciate that other types of indicators, such as, but not limited to, an audio speaker or a display may be used to alert the customer.

Transaction instrument 108 may further include a location module 520. Location module 520 determines a geographical location of transaction instrument 108 using various location techniques known in the art, for example, Global Positioning System (GPS). Further, location module 520 may send the geographical location to processor 510, which in turn may forward the geographical location to message delivery system 102. According to one embodiment, message delivery system 102 may match the customer's current geographical location with geographic locations of the customer's favorite merchant stores. When the customer is within a pre-defined geographic vicinity of any of the favorite merchant stores, message delivery system 102 may select one or more messages corresponding to the favorite merchant store and send the selected messages to transaction instrument 108. The location module 520 may also leverage other devices in order to determine a geographical location of transaction instrument 108. For example, a GPS located on a transaction instrument 108 user's cell phone may be leveraged by location module 520 to determine a geographical location of transaction instrument 108.

Transaction instrument 108 may further include an ON/OFF button 522 that may enable the customer to manually turn OFF display 504, according to one embodiment. In an alternate implementation, the customer may disable transaction instrument's 108 capability of receiving and presenting offers using ON/OFF button 522 as desired, for example, when the customer is at home, at the workplace or on an airplane. Further, in some embodiments, for privacy reasons, the customer may not want the transaction instrument 108 to be discovered automatically or may not wish the transaction instrument 108 to notify its geographical location to message delivery system 102. In this case, the customer may set corresponding privacy preferences with card issuer 104 and when the customer activates the transaction instrument 108 for the first time, these preferences may be downloaded to the transaction instrument 108. Using these preferences, auto-discovery capability and location module 520 may be disabled. Consequently, the customer has control over when to receive messages and may present the transaction instrument 108 at communication node 110 at that time.

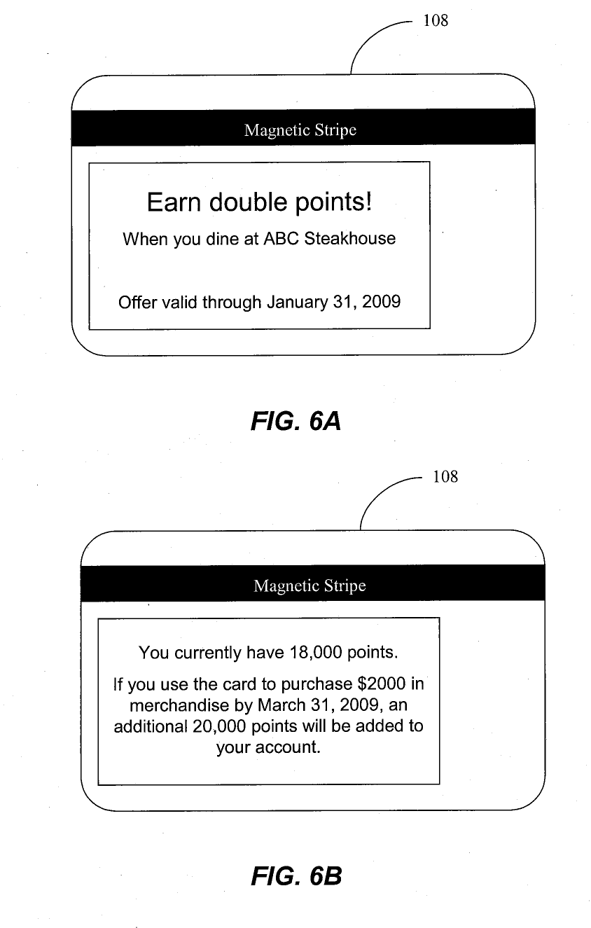

FIG. 6A illustrates presentation of an exemplary message on transaction instrument 108, according to one embodiment of the present invention. Card issuer 104 may have a business agreement or partnership with merchant 106 (in this example, ABC Steakhouse).

When a customer having transaction instrument 108 enters ABC Steakhouse, communication node 110 at ABC Steakhouse discovers the transaction instrument 108. Subsequent to discovery, the transaction instrument 108 sends a request for messages to message delivery system 102 via communication node 110. Communication node 110 also sends the merchant specific information, i.e., “ABC Steakhouse” and “New York” to message delivery system 102. The message delivery system 102 selects the message “Earn double points when dining at ABC Steakhouse—offer valid through Jan. 31, 2009” for the customer's transaction instrument 108. Message delivery system 102 sends the message to transaction instrument 108 via communication node 110. Transaction instrument 108 displays the selected message to the customer as shown in FIG. 6A.

FIG. 6B illustrates presentation of another exemplary message on transaction instrument 108, according to one embodiment, when the customer is at a mall. The mall may have stores of multiple merchants. However, card issuer 104 may not have a business agreement or partnership with any merchant having stores in the mall.

When a customer having a transaction instrument 108 enters the mall, message delivery system 102 discovers the customer's transaction instrument 108 either directly or via communication node 110 deployed, for example, as an access point or as a kiosk, at the mall. Alternatively, message delivery system 102 may determine the transaction instrument's 108 current geographic location using location module 314 and infer that the customer is at the mall. Upon discovery, the transaction instrument 108 sends a request to message delivery system 102 for messages. Message delivery system 102 then obtains the transaction instrument type and the loyalty program number and the loyalty program points of the customer using the request. Message delivery system 102 selects a message for the customer considering the transaction instrument type, the loyalty program points and the geographic location. The message may not relate to any particular merchant, since card issuer 104 does not have a partnership with any merchant. An example of such a message may be “You currently have 18,000 points. If you use the card to purchase $2,000 in merchandise by Mar. 31, 2009, an additional 20,000 points will be added to your account.” Message delivery system 102 provides the message to the transaction instrument 108 and the message is then presented on the transaction instrument's 108 display 504.

### III. Process

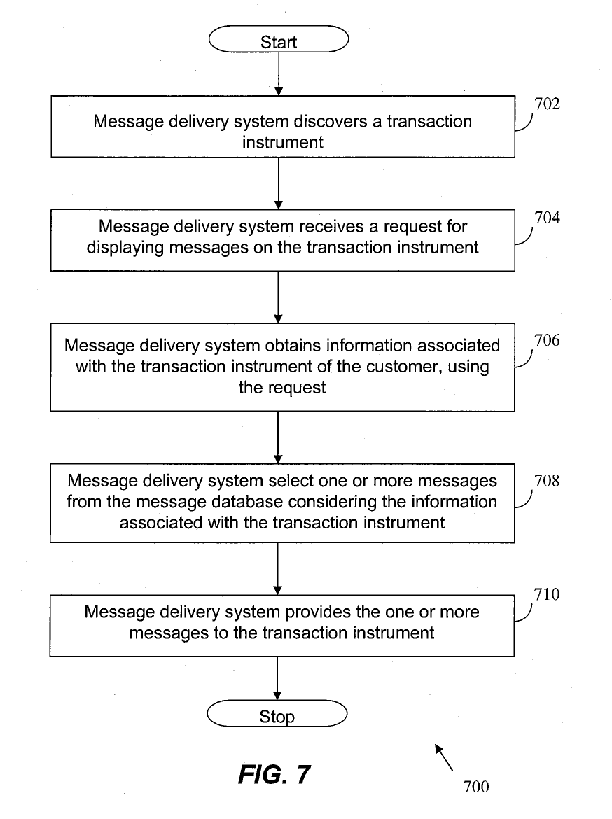

FIG. 7 is a flowchart illustrating an exemplary process 700 for providing messages to a customer having a transaction instrument, according to one embodiment of the present invention. In step 702, message delivery system 102 discovers transaction instrument 108 of the customer. In one embodiment, message delivery system 102 may discover transaction instrument 108 automatically. In another embodiment, communication node 110 may discover transaction instrument 108.

In step 704, message delivery system 102 receives a request for messages corresponding to transaction instrument 108. Depending on the deployment scenario, message delivery system 102 receives the request either directly from transaction instrument 108, or relayed through communication node 110. The request may include the card information or a token representing the card information. The card information may include one or more of a transaction instrument issuer name, a transaction instrument type, a transaction instrument number, a transaction instrument account number, a transaction instrument account type, a loyalty program number, loyalty program points, a loyalty program identifier and the like. In some embodiments, message delivery system 102 may also receive the merchant-specific information along with the request.

In step 706, message delivery system 102 obtains the card information associated with transaction instrument 108 using the request. Message delivery system 102 may extract the token from the request and then retrieve the card information using the token. Alternatively, message delivery system 102 may extract the card information from the request. Further, in some embodiments, message delivery system 102 may also retrieve the customer information using either the request or the card information.

In step 708, message delivery system 102 selects one or more messages from messages database 304 based, at least in part, on the card information. Message delivery system 102 may also use the merchant specific information to select the one or more messages, according to some embodiments. In further embodiments, message delivery system 102 may also use the customer-specific information to select the one or more messages. In additional embodiments, message delivery system 102 may determine a geographical location of transaction instrument 108, and use the geographical location while selecting the messages.

In step 710, message delivery system 102 provides the selected messages to transaction instrument 108. Message delivery system 102 may provide the selected messages either directly to transaction instrument 108 or through communication node 110, depending upon the deployment scenario. Transaction instrument 108 then presents the messages to the customer on display 504.

Although the above examples have used the transaction instrument 108 as a financial transaction instrument, a person skilled in the art would recognize various other uses of the transaction instrument. For example, in the health care field, an insurance company may issue transaction instruments 108 to its insured customers to provide information to the customers regarding health care coverage. For instance, the transaction instrument may inform a user that an insurance policy is about to expire or that a prescription medication needs to be renewed.

### IV. Example Implementations

The present invention (i.e., system 102, system 110, process 700, or any part(s) or function(s) thereof) may be implemented using hardware, software or a combination thereof, and may be implemented in one or more computer systems or other processing systems. However, the manipulations performed by the present invention were often referred to in terms, such as comparing or checking, which are commonly associated with mental operations performed by a human operator. No such capability of a human operator is necessary, or desirable in most cases, in any of the operations described herein, which form a part of the present invention. Rather, the operations are machine operations. Useful machines for performing the operations in the present invention may include general-purpose digital computers or similar devices.

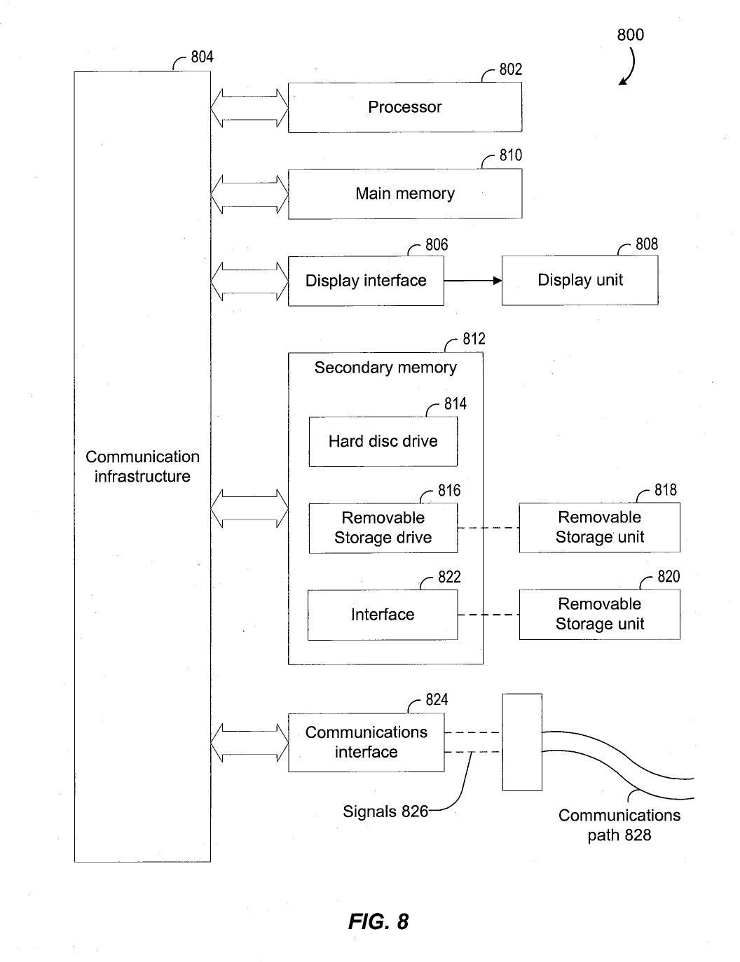

In fact, in accordance with an embodiment of the present invention, the present invention is directed towards one or more computer systems capable of carrying out the functionality described herein. An example of the computer systems includes a computer system 800, which is shown in FIG. 8.

The computer system 800 includes at least one processor, such as a processor 802. Processor 802 is connected to a communication infrastructure 804, for example, a communications bus, a cross over bar, a network, and the like. Various software embodiments are described in terms of this exemplary computer system 800. After reading this description, it will become apparent to a person skilled in the relevant art(s) how to implement the present invention using other computer systems and/or architectures.

The computer system 800 includes a display interface 806 that forwards graphics, text, and other data from the communication infrastructure 804 (or from a frame buffer which is not shown in FIG. 8) for display on a display unit 808.

The computer system 800 further includes a main memory 810, such as random access memory (RAM), and may also include a secondary memory 812. The secondary memory 812 may further include, for example, a hard disk drive 814 and/or a removable storage drive 816, representing a floppy disk drive, a magnetic tape drive, an optical disk drive, etc. The removable storage drive 816 reads from and/or writes to a removable storage unit 818 in a well known manner. The removable storage unit 818 may represent a floppy disk, magnetic tape or an optical disk, and may be read by and written to by the removable storage drive 816. As will be appreciated, the removable storage unit 818 includes a computer usable storage medium having stored therein computer software and/or data.

In accordance with various embodiments of the present invention, the secondary memory 812 may include other similar devices for allowing computer programs or other instructions to be loaded into the computer system 800. Such devices may include, for example, a removable storage unit 820, and an interface 822. Examples of such may include a program cartridge and cartridge interface (such as that found in video game devices), a removable memory chip (such as an erasable programmable read only memory (EPROM), or programmable read only memory (PROM)) and associated socket, and other removable storage units 820 and interfaces 822, which allow software and data to be transferred from the removable storage unit 820 to the computer system 800.

The computer system 800 may further include a communication interface 824. The communication interface 824 allows software and data to be transferred between the computer system 800 and external devices. Examples of the communication interface 824 includes, but are not limited to, a modem, a network interface (such as an Ethernet card), a communications port, a Personal Computer Memory Card International Association (PCMCIA) slot and card, and the like. Software and data transferred via the communication interface 824 are in the form of a plurality of signals, hereinafter referred to as signals 826, which may be electronic, electromagnetic, optical or other signals capable of being received by the communication interface 824. The signals 826 are provided to the communication interface 824 via a communication path (e.g., channel) 828. Communication path 828 carries the signals 826 and may be implemented using wire or cable, fiber optics, a telephone line, a cellular link, a radio frequency (RF) link and other communication channels.

In this document, the terms “computer program medium” and “computer usable medium” are used to generally refer to media such as the removable storage drive 816, a hard disk installed in hard disk drive 814, the signals 826, and the like. These computer program products provide software to the computer system 800. The present invention is directed to such computer program products.

Computer programs (also referred to as computer control logic) are stored in the main memory 810 and/or the secondary memory 812. Computer programs may also be received via the communication infrastructure 804. Such computer programs, when executed, enable the computer system 800 to perform the features of the present invention, as discussed herein. In particular, the computer programs, when executed, enable the processor 802 to perform the features of the present invention. Accordingly, such computer programs represent controllers of the computer system 800.

In accordance with an embodiment of the invention, where the invention is implemented using software, the software may be stored in a computer program product and loaded into the computer system 800 using the removable storage drive 816, the hard disk drive 814 or the communication interface 824. The control logic (software), when executed by the processor 802, causes the processor 802 to perform the functions of the present invention as described herein.

In another embodiment, the present invention is implemented primarily in hardware using, for example, hardware components such as application specific integrated circuits (ASIC). Implementation of the hardware machine so as to perform the functions described herein will be apparent to persons skilled in the relevant art(s).

In yet another embodiment, the present invention is implemented using a combination of both the hardware and the software.

The various embodiments of the present invention described above have been presented by way of example and not limitation. It will be apparent to persons skilled in the relevant art(s) that various changes in form and detail can be made therein (e.g., different hardware, communications protocols, and the like) without departing from the spirit and scope of the present invention. Thus, the present invention should not be limited by any of the above-described exemplary embodiments, but should be defined only in accordance with the following claims and their equivalents. It is also to be understood that the steps and processes recited in the claims need not be performed in the order presented.

In addition, it should be understood that the attached drawings, which highlight the functionality and advantages of the present invention, are presented as illustrative examples. The architecture of the present invention is sufficiently flexible and configurable, such that it may be utilized (and navigated) in ways other than that shown in the drawings.

Further, the purpose of the appended Abstract is to enable the U.S. Patent and Trademark Office and the public generally, and especially scientists, engineers, and practitioners in the relevant art(s), who are not familiar with patent or legal terms and/or phraseology, to determine quickly from a cursory inspection the nature and essence of the technical subject matter disclosed herein. The Abstract is not intended to be limiting as to the scope of the present invention in any way.

1. A method for providing messages to a customer, the method comprising the steps of:
receiving, at a server, a request for messages from a transaction instrument of the customer;
obtaining information associated with the transaction instrument using the request for messages;
selecting at least one message, from a message database, based, at least in part, on the information associated with the transaction instrument; and
providing data corresponding to the at least one message to the transaction instrument,
wherein the steps are performed on at least one processor.

2. The method of claim 1, wherein the obtaining step comprises:
extracting a token from the request for messages; and
retrieving the information associated with the transaction instrument using the token.

3. The method of claim 1, wherein the obtaining step comprises:
extracting the information associated with the transaction instrument from the request for messages.

4. The method of claim 1, wherein the information associated with the transaction instrument comprises at least one of transaction instrument issuer, transaction instrument type, transaction instrument number, transaction instrument account number, transaction instrument account type, loyalty program number, and a loyalty program identifier.

5. The method of claim 1, further comprising:
detecting a location of the transaction instrument; and
providing the at least one message also based on the location.

6. The method of claim 1, further comprising:
discovering the transaction instrument.

7. The method of claim 1, further comprising:
providing a message code corresponding to each of the messages to the transaction instrument.

8. The method of claim 1, wherein selecting the at least one message comprises selecting the at least one message also based upon at least one of information associated with the customer and information associated with a merchant.

9. The method of claim 1, wherein the method is performed in a closed loop environment.

10. A system for providing messages to a customer, the system comprising:
a messages database for maintaining a plurality of messages; and
a server comprising:
a receiving module for receiving a request for messages from a transaction instrument of the customer;
an information retrieval module for obtaining information associated with the transaction instrument of the customer using the request for messages;
a selection module for selecting at least one message from the messages database based, at least in part, on the information associated with the transaction instrument; and
a sending module for sending data corresponding to the at least one message to the transaction instrument.

11. The system of claim 10, further comprising a location module for determining the location of the transaction instrument.

12. The system of claim 10, wherein the system is a closed loop system.

13. An apparatus for providing messages to a customer, the apparatus comprising:
a discovery module for discovering a transaction instrument of the customer; and
a communication module for forwarding a request for messages from the transaction instrument to a server and for forwarding data corresponding to at least one message received from the server to the transaction instrument.

14. The apparatus of claim 13, wherein the apparatus is one of a point-of-sales device, a kiosk, a card reader, or an access point.

15. The apparatus of claim 13, wherein the communication module communicates with the transaction instrument using one of Global System for Mobile communications (GSM), Code Division Multiple Access (CDMA), Universal Mobile Telecommunication system (UMTS), General Packet Radio Service (GPRS), Wireless Fidelity (IEEE 802.11 Wi-Fi), Worldwide Interoperability for Microwave Access (IEEE 802.16 WIMAX), Bluetooth, Radio Frequency Identification (RFID), or Near Field Communication (NFC).

16. A transaction instrument of a customer, the transaction instrument comprising:
a transmission module for transmitting a request for messages from the transaction instrument to a server;
a reception module for receiving data of at least one message from the server; and
a display for presenting the at least one message to the customer.

17. The transaction instrument of claim 16, wherein the transaction instrument is one of a credit card, a debit card, a pre-paid card, a charge card, a loyalty card, or a gift card.

18. The transaction instrument of claim 16, wherein the display is one of an LCD, an LED display, an OLED display or an electronic ink display.

19. The transaction instrument of claim 16, further comprising a second display located on an opposite said of the transaction instrument from the display.

20. The transaction instrument of claim 16, wherein the at least one message is an offer with a two-dimensional barcode and the two-dimensional barcode is displayed on the display.

21. The transaction instrument of claim 16, wherein the transmission module is one of a GSM transmitter, a CDMA transmitter, a UMTS transmitter, a GPRS transmitter, an IEEE 802.11 Wi-Fi transmitter, an IEEE 802.16 WiMAX transmitter, a Bluetooth transmitter, an RFID transmitter, and an NFC.

22. The transaction instrument of claim 16, wherein the reception module is one of a GSM receiver, a CDMA receiver, a UMTS receiver, a GPRS receiver, an IEEE 802.11 Wi-Fi receiver, an IEEE 802.16 WiMAX receiver, a Bluetooth receiver, an RFID receiver, and an NFC receiver.

23. The transaction instrument of claim 16, further comprising a location module for determining a location of the transaction instrument.

24. The transaction instrument of claim 16, further comprising at least one command sensor for detecting at least one command from the customer.

25. The transaction instrument of claim 16, further comprising at least one activation sensor for detecting a trigger for activating the display.

26. The transaction instrument of claim 16, further comprising at least one indicator for indicating receipt of the at least one message.

27. The transaction instrument of claim 16, further comprising a memory for storing the at least one message.
